(19) United States
(12) Patent Application Publication
(10) Pub. No.: US 2026/0133352 A1
(43) Pub. Date: May 14, 2026

(54) LASER PROCESSING SYSTEM AND OPTICAL DIFFRACTION ELEMENT

(71) Applicant: INDUSTRIAL TECHNOLOGY RESEARCH INSTITUTE, Hsinchu (TW)

(72) Inventors: Jyun-Jhih WANG, Taichung City (TW); Jui-Ping CHANG, Kaohsiung City (TW); Chun-Ming CHEN, Tainan City (TW); Yu-Chung LIN, Yongkang City (TW); Chien-Jung HUANG, Tainan City (TW)

(73) Assignee: INDUSTRIAL TECHNOLOGY RESEARCH INSTITUTE, Hsinchu (TW)

(21) Appl. No.: 18/978,676

(22) Filed: Dec. 12, 2024

(30) Foreign Application Priority Data
Nov. 11, 2024 (TW) 113143213

(51) Int. Cl. G02B 5/18; B23K 26/06; B23K 26/067; B23K 26/53; B23K 101/40

(52) U.S. Cl. CPC G02B 5/1866; B23K 26/0648; B23K 26/067; B23K 26/53; B23K 2101/40

(57) ABSTRACT

A laser processing system and an optical diffraction element used for internal modification to an object are disclosed. The laser processing system includes a laser source, an optical diffraction element and a focusing lens set. The optical diffraction element is optically coupled to the laser source, and has first and second periodic structures staggered with each other. The quantity of the first microstructures of the first periodic structures is greater than the quantity of the second microstructures of the second periodic structures. The optical diffraction element is configured to generate first diffracted lights and second diffracted lights staggered with each other. The focusing lens set is optically coupled to the optical diffraction element and configured to focus the diffracted lights into the object.

### CROSS-REFERENCE TO RELATED APPLICATIONS

This non-provisional application claims priority under 35 U.S.C. § 119(a) on Patent Application No(s). 113143213 filed in Republic of China (Taiwan) on Nov. 11, 2024, the entire contents of which are hereby incorporated by reference.

### BACKGROUND

### 1. Technical Field

The present disclosure relates to a laser processing system and an optical diffraction element.

### 2. Related Art

In semiconductor manufacturing processes, wafer slicing refers to the procedure of cutting fabricated crystal ingots, such as silicon ingots, into wafer slices. Currently, the mainstream method involves using a diamond wire saw for slicing.

Moreover, focusing the laser to the internal modification regions within ingots to form cracks for subsequent die separation has gradually become more common.

### SUMMARY

According to an embodiment of this disclosure, a laser processing system is configured to performing internal modification on an object to be processed. The laser processing system includes a laser source, an optical diffraction element, and a focusing lens set. The laser source is configured to generate a laser beam. The optical diffraction element is optically coupled to the laser source. The optical diffraction element has a surface with a plurality of first periodic structures and a plurality of second periodic structures staggered with each other. Each of the plurality of first periodic structures comprising a plurality of first microstructures with same characteristic length. Each of the second periodic structures comprise a plurality of second microstructures with same characteristic length. The optical diffraction element is configured to generate a plurality of first diffracted lights and a plurality of second diffracted lights staggered with each other from the laser beam. The focusing lens set is optically coupled to the optical diffraction element, and configured to focus the plurality of first diffracted lights and the plurality of second diffracted lights to an object to be processed.

According to an embodiment of this disclosure, an optical diffraction element is configured to generate a plurality of first diffracted lights and a plurality of second diffracted lights staggered with each other from a laser beam. The optical diffraction element comprises a plurality of first periodic structures and a plurality of second periodic structures. Each of the first periodic structures comprises a plurality of first microstructures with same characteristic length. Each of the second periodic structures comprises a plurality of second microstructures with same characteristic length. The first periodic structures and the second periodic structures staggered with each other. The quantity of the first microstructures of each of the first periodic structures is greater than the quantity of the second microstructures of each of the second periodic structures.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a laser processing system illustrated according to an embodiment of this disclosure;

FIGS. 2 and 3 are schematic diagrams of an optical diffraction element illustrated according to an embodiment of this disclosure;

FIG. 4 is a schematic diagram of an optical diffraction element illustrated according to another embodiment of this disclosure;

FIG. 5 is a schematic diagram of the multi-order diffracted lights generated by the optical diffraction element illustrated according to an embodiment of this disclosure;

FIG. 6 is a graph showing the luminous intensity distribution of the multi-order diffracted lights generated by the optical diffraction element illustrated according to an embodiment of this disclosure;

FIG. 7 is a graph showing the relationship between the diffraction efficiency of the optical diffraction element and the quantity of split order, as illustrated according to an embodiment of this disclosure;

FIG. 8 shows the formation of continuous cracks in the internal modification region of the object to be processed by the multi-order diffracted lights, as illustrated according to an embodiment of this disclosure;

FIG. 9 shows the surface condition of the material after processing using single-point laser modification technology; and

FIG. 10 shows the surface condition of the material after processing by using the laser processing system of an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The term “coupled” or “coupling” refers to any connection, linkage, or similar relationship, and “optically coupled” or “optical coupling” refers to the relationship in which light impart from one component to another. Unless otherwise specified, components that are coupled or connected to each other do not need to be directly connected and may be spaced apart through intermediate components.

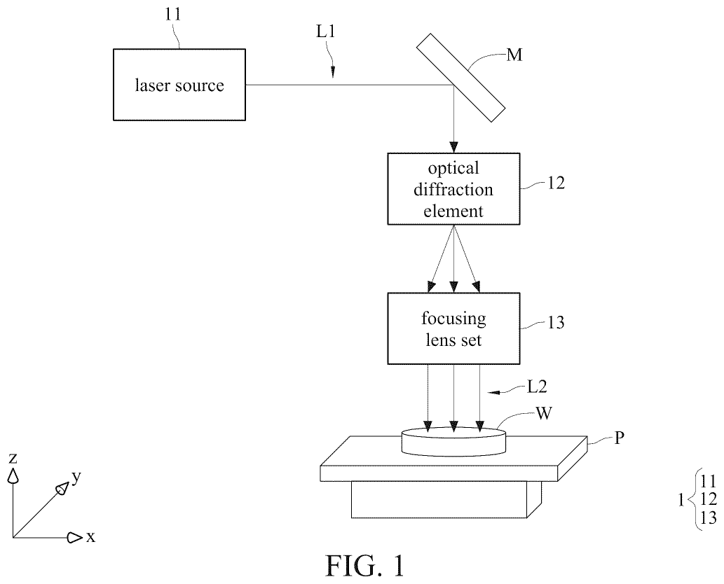

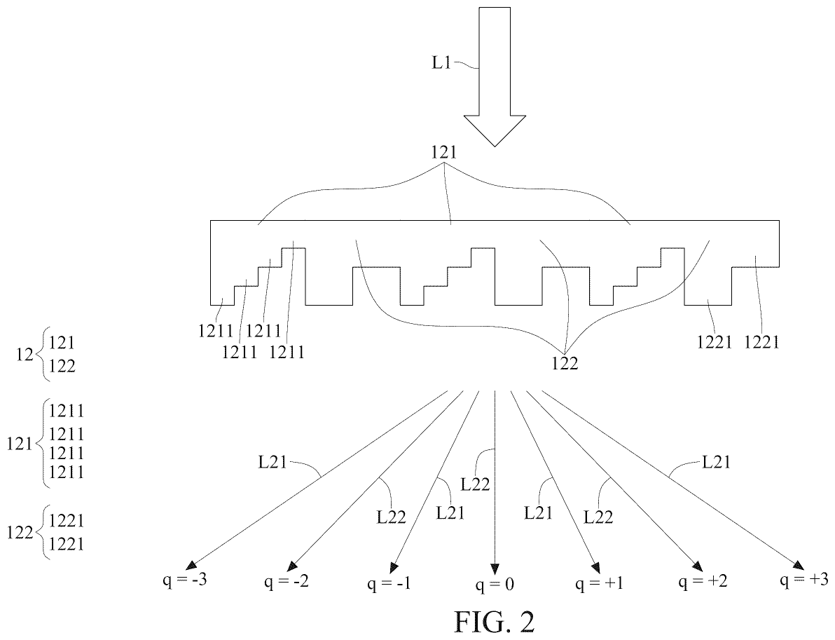

Please refer to FIGS. 1 and 2, wherein FIG. 1 is a schematic diagram of a laser processing system illustrated according to an embodiment of this disclosure. As shown in FIGS. 1 and 2, a laser processing system 1 is configured to perform internal modification on an object to be processed W or a wafer carried by a processing platform P. The laser processing system 1 includes a laser source 11, an optical diffraction element 12, and a focusing lens set 13. The optical diffraction element 12 is optically coupled to the laser source 11, and the surface of the optical diffraction element 12 has a plurality of first periodic structures 121 and a plurality of second periodic structures 122 that are staggered with each other. The optical diffraction element 12 is configured to generate at least one first diffracted light L21 and at least one second diffracted light L22 from the laser beam L1, which are staggered with each other. The focusing lens set 13 is optically coupled to the optical diffraction element 12 and configured to focus the at least one first diffracted light L21 and the at least one second diffracted light L22 to the inside of the surface of the object to be processed W.

The laser processing system 1 of this disclosure is configured to perform internal modification on the object to be processed W, wherein the laser source 11 may be, for example, a continuous wave laser (CW laser) device or a pulsed laser device. For example, the wavelength of the laser beam L1 output by the pulsed laser device may fall within the visible or infrared wavelength range, with a pulse width on the order of nanoseconds (ns), picoseconds (ps), or femtoseconds (fs). The object to be processed W may be a semiconductor material such as silicon carbide (SiC) or other materials such as silicon dioxide (SiO₂). In practice, appropriate laser parameters may be selected based on different materials to perform internal modification on the material. For example, a laser beam with a wavelength in the near-infrared range (such as 1064 nm) may be used for silicon carbide materials, while a laser beam with a wavelength in the green or ultraviolet range (such as 532 nm or 343 nm) may be used for silicon dioxide materials. Moreover, a control device (not shown) may be specifically configured to control the laser parameters of the laser source 11. Alternatively, the control device may be configured to perform integrated control of various components of the laser processing system 1, such as translational control of the processing platform P, and the present disclosure is not limited thereto.

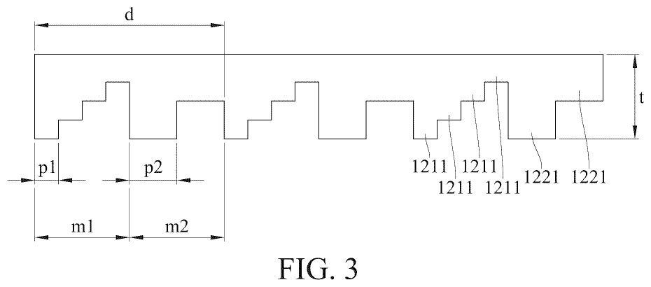

The laser beam L1 output by the laser source 11 may be directed to the optical diffraction element 12 via one or more reflective mirrors M so as to form multiple diffracted lights L2. The reflective mirror M may have a high reflectivity for the wavelength range of the laser source 11. The surface of the reflective mirror M may be coated with a specific metallic material, such as gold or silver, or it may be coated with a dielectric layer that offers a high reflectivity across multiple wavelengths. Please refer to FIGS. 2 and 3, which are schematic diagrams of the optical diffraction element illustrated according to an embodiment of this disclosure. As shown in FIGS. 2 and 3, the optical diffraction element 12 is configured to generate a plurality of first diffracted lights L21 and a plurality of second diffracted lights L22 staggered with each other from the laser beam L1. The surface of the optical diffraction element 12 includes a plurality of first periodic structures 121 and a plurality of second periodic structures 122, which are staggered with each other. Each of the first periodic structures 121 may include a plurality of first microstructures 1211. Each of the second periodic structures 122 may include a plurality of second microstructures 1221. The first periodic structures 121 and the second periodic structures 122 are staggered with each other, and the quantity of first microstructures 1211 of single period is greater than the quantity of second microstructures 1221.

In this embodiment, the optical diffraction element 12 may be a grating or another element with two types of periodic structures to produce a specific diffraction effect. For example, the optical diffraction element 12 may be made by etching two staggered periodic structures onto a substrate, or by further etching an additional periodic structure onto a grating that originally has a single periodic structure. FIG. 2 illustrates that the first microstructures 1211 of the first periodic structures 121 are stair-shaped, and the second microstructures 1221 of the second periodic structures 122 are also stair-shaped, and the present disclosure is not limited thereto. For example, the first microstructures 1211 and second microstructures 1221 may be sawtooth-shaped or have other forms. Furthermore, the first microstructures 1211 and second microstructures 1221 may have different shapes. In this embodiment, the quantity of the first microstructures 1211 of single period is greater than the quantity of the second microstructures 1221. For example, the quantity of the first microstructures 1211 of a single first periodic structure 121 may be 4, and the quantity of the second microstructures 1221 of a single second periodic structure 122 may be 2, and the present disclosure is not limited thereto. Through the above configuration, the optical diffraction element 12 may generate a 0-order diffracted light, ±1-order diffracted lights, ±2-order diffracted lights, ±3-order diffracted lights, and so on, distributed along the single alignment direction of the periodic structures (X direction). These diffracted lights may be classified into first diffracted lights L21, which have higher intensity (higher diffraction efficiency), and second diffracted lights L22, which have lower intensity (lower diffraction efficiency). Specifically, the ±1-order diffracted lights and ±3-order diffracted lights may be the first diffracted lights L21, while the 0-order diffracted light and ±2-order diffracted lights may be the second diffracted lights L22. In other embodiments, the 0-order diffracted light and ±2-order diffracted lights may have higher intensity (higher diffraction efficiency), while the ±1-order diffracted lights and ±3-order diffracted lights may have lower intensity (lower diffraction efficiency), and the present disclosure is not limited thereto.

Please refer to FIG. 3, wherein the periodic length of a single first periodic structure 121 and an adjacent single second periodic structure 122 is denoted as d. The first periodic structures 121 have a first structural length m1, and the second periodic structures 122 have a second structural length m2. The first structural length m1 of the first periodic structures 121 and the second structural length m2 of the second periodic structures 122 may be the same. The first periodic structures 121 have a thickness, and the second periodic structures 122 have a thickness. That is, the first periodic structures 121 and the second periodic structures 122 may have the same thickness t. The first microstructures 1211 may have the same first characteristic length p1, and the second microstructures 1221 may have the same second characteristic length p2. The first characteristic length p1 of each first microstructure 1211 is smaller than the second characteristic length p2 of each second microstructure 1221. Moreover, although FIGS. 2 and 3 merely illustrate three sets of periodic structures, the optical diffraction element 12 may include more periodic structures.

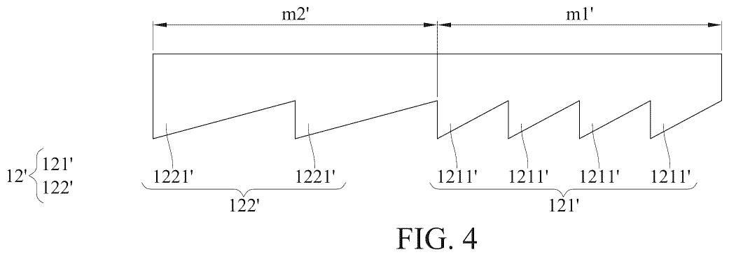

Please refer to FIG. 4, which is a schematic diagram of an optical diffraction element illustrated according to another embodiment of this disclosure. In this embodiment, as shown in FIG. 4, an optical diffraction element 12 includes the first periodic structures 121 and the second periodic structures 122. The first microstructures 1211 of the first periodic structures 121 may be sawtooth-shaped, and the second microstructures 1221 of the second periodic structures 122 may also be sawtooth-shaped. The first structural length m1 of the first periodic structures 121 is, for example, equal to the second structural length m2 of the second periodic structures 122. Therefore, the quantity of the first microstructures 1211 is greater than the quantity of the second microstructures 1221. For example, the quantity of the first microstructures 1211 of the first periodic structures 121 may be 4, and the quantity of the second microstructures 1221 of the second periodic structures 122 may be 2, and the present disclosure is not limited thereto.

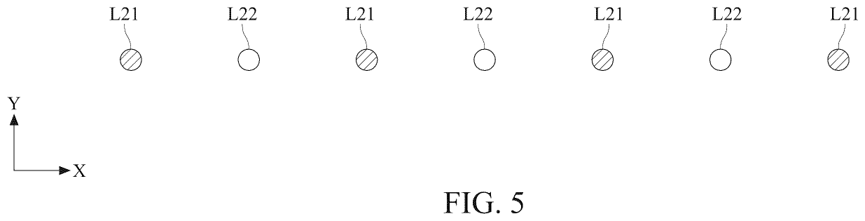

The multiple diffracted lights L2 generated by the optical diffraction element 12 may be focused on the surface of the object to be processed W by the focusing lens set 13 to perform internal modification. The focusing lens set 13 may include one or more focusing lenses, and the focal length may be determined based on the relative positions of the optical diffraction element 12, the focusing lens set 13, and the object to be processed W, and the present disclosure is not limited thereto. Please refer to FIG. 5, which is a schematic diagram of the multi-order diffracted lights generated by the optical diffraction element illustrated according to an embodiment of this disclosure. As shown in FIG. 5, the diffracted lights L2 are distributed along one direction (the Z direction) and irradiate the surface of the object to be processed W for internal modification, wherein the first diffracted lights L21 may have higher intensity (higher diffraction efficiency), and the second diffracted lights L22 may have lower intensity (lower diffraction efficiency). The processing platform P may carry the object to be processed W and translate along another direction (X or Y direction). Therefore, the laser scanning distance between the diffracted lights L2 may be increased, effectively increasing the speed of laser modification. For example, the arrangement direction (X direction) of the first diffracted lights L21 and the second diffracted lights L22 may be perpendicular to the translation direction (Y direction) of the processing platform P, and the present disclosure is not limited thereto.

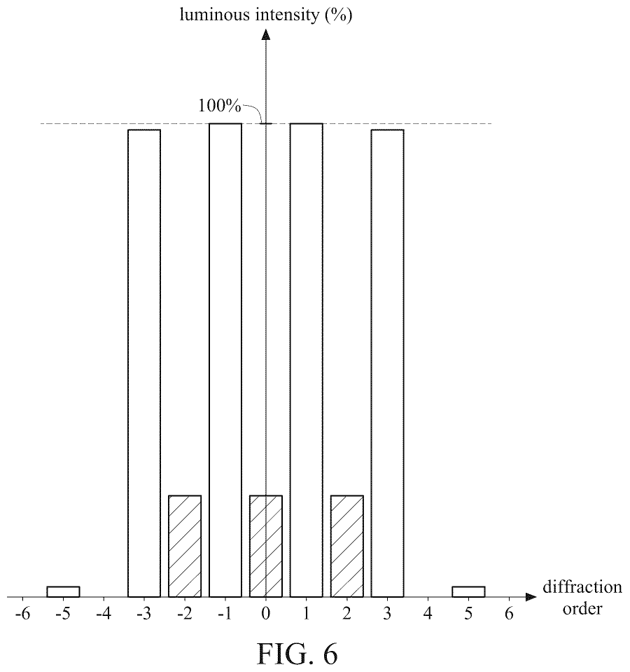

Please refer to FIG. 6, which is a graph showing the luminous intensity distribution of the multi-order diffracted lights generated by the optical diffraction element illustrated according to an embodiment of this disclosure. As shown in FIG. 6, the relative intensity relationship of the multi-order diffracted lights generated by the optical diffraction element in the aforementioned embodiment may be as follows: the ±1-order diffracted lights have the highest diffraction efficiency (defined as having 100% luminous intensity); the ±3-order diffracted lights have the next highest diffraction efficiency (with more than 90% of the luminous intensity compared to the ±1st-order diffracted lights); the 0-order and ±2-order diffracted lights have lower diffraction efficiencies (with 20% to 30% of the luminous intensity compared to the ±1-order diffracted lights); the luminous intensity of the higher-order diffracted lights may be negligible compared to the ±1-order diffracted lights. Also referring FIGS. 2 and 5, the ±1-order diffracted lights and ±3-order diffracted lights may be the first diffracted lights L21, which are generated by the first periodic structures 121; the 0-order and ±2-order diffracted lights may be the second diffracted lights L22, which are generated by the second periodic structures 122.

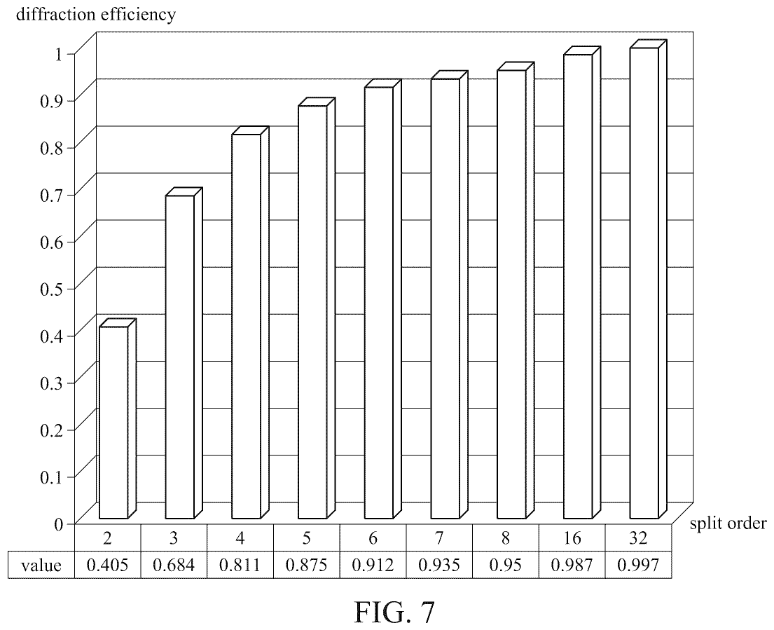

Regarding the diffraction efficiency difference between the first periodic structures 121 and the second periodic structures 122, please refer to FIG. 7, which is a graph showing the relationship between the diffraction efficiency of the optical diffraction element and the quantity of split order, as illustrated according to an embodiment of this disclosure. As shown in FIG. 7, it may be observed that the more split orders the optical diffraction element has, the higher its diffraction efficiency. Therefore, the optical diffraction element of this disclosure includes two types of periodic structures with different split orders, which may produce an effect where two types of diffracted lights with different intensities are staggered with each other, which may effectively increasing the laser scanning distance, thereby improving the speed of laser modification. Particularly, by making the intensities of the two types of diffracted lights with staggered distribution have a specific proportional relationship therebetween, the wafer die separation yield of the laser modification may be improved. For example, using the first periodic structures with a split order of 4 in combination with the second periodic structures with a split order of 2 may allow the intensity of the second diffracted lights to be 20% to 30% of the intensity of the first diffracted lights. This arrangement forms cracks that are connected along the one-dimensional direction, linking the cracks together and improving the wafer die separation yield. Regarding the diffraction efficiency and split order relationship graph in FIG. 7, it may be obtained by calculating based on the diffraction efficiency equation of the grating. Please refer to the following equation (1). In equation (1), η is the diffraction efficiency, m is the split order (diffraction order), p is the quantity of microstructures (phase layers), and d is the thickness.

$$η = \frac{sin {c}^{2} ( m / p ) {sin}^{2} ( π ( d - m ) )}{{p}^{2} {sin}^{2} ( \frac{π}{p} ( d - m ) )} \qquad equation ( 1 )$$

Based on the above equation (1), one skilled in the art may calculate or simulate the relationship between the split order and diffraction efficiency for various shapes of gratings (periodic structures), and obtain a graph similar to FIG. 7. Accordingly, two or more split orders may be selected to form different periodic structures so that processing with diffracted lights of different intensities staggered with each other may be achieved. It should be noted that although the above embodiments describe an optical diffraction element primarily generating seven diffracted lights (four first diffracted lights and three second diffracted lights), in other embodiments, the optical diffraction element may generate, for example, five diffracted lights (three first diffracted lights and two second diffracted lights), or three diffracted lights (two first diffracted lights and one second diffracted light). This disclosure does not impose any limitations on the actual quantity of diffracted lights generated.

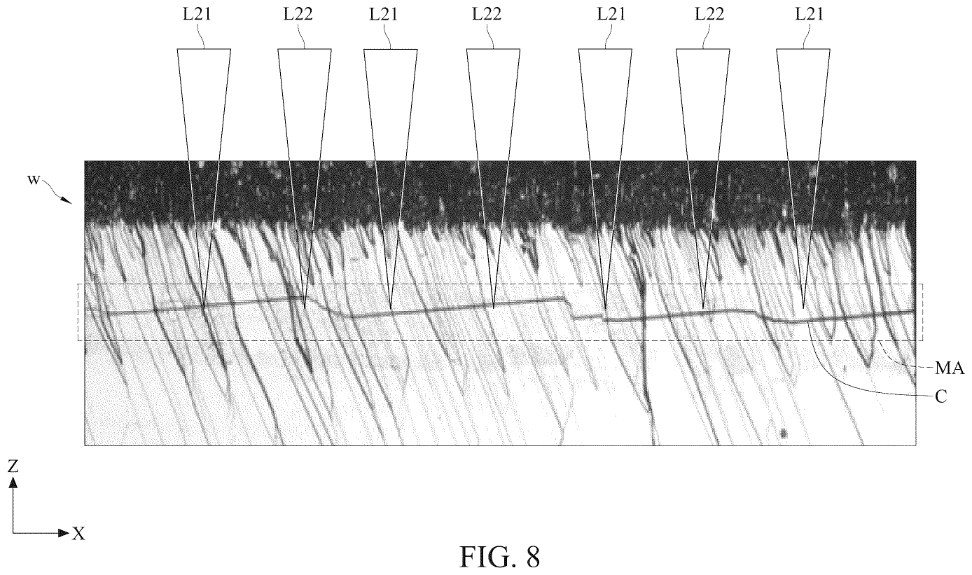

Please refer to FIG. 8, which shows the formation of continuous cracks in the internal modification region of the object to be processed by the multi-order diffracted lights, as illustrated according to an embodiment of this disclosure. As shown in FIG. 8, the staggered distribution first diffracted lights L21 and second diffracted lights L22 may be focused by the focusing lens set to a specified depth inside the object to be processed W, thereby forming a modified area MA. In the modified area MA, the first diffracted lights L21, which have higher intensity, may generate deeper cracks, while the second diffracted lights L22, which have lower intensity, may generate shallower cracks between the two first diffracted lights L21. Therefore, the diffracted lights may form continuous cracks C within the object to be processed W, and avoid the issue of uneven crack length caused by the concentration of thermal stress.

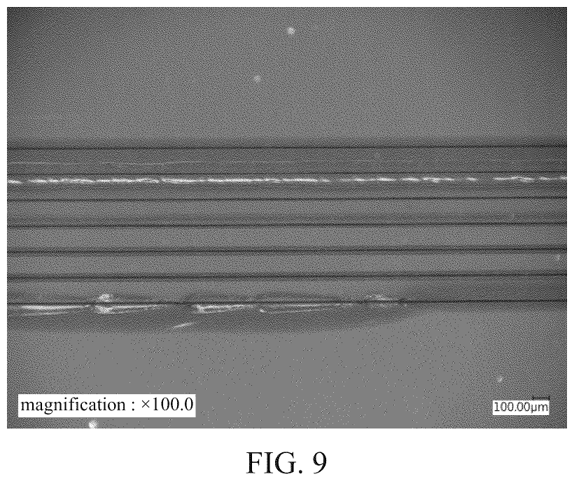

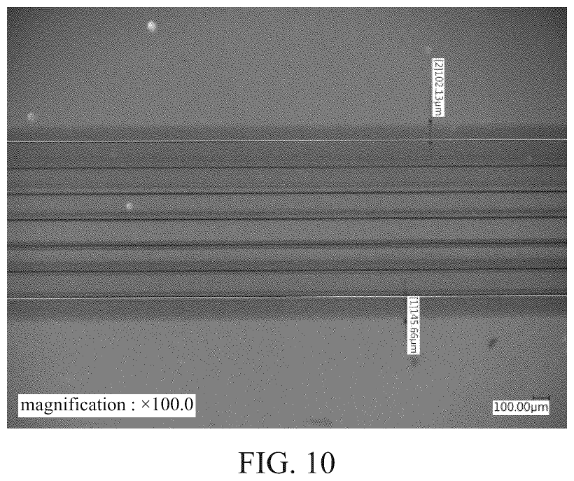

Please refer to FIG. 9, which shows the surface condition of the material after processing using single-point laser modification technology. As shown in FIG. 9, a single-point processing method is used to form modification points inside the material tends, resulting in significant local thermal stress differences. This leads to uneven crack lengths, thereby reducing the success rate of subsequent dicing. Specifically, as illustrated in FIG. 9, the cracks formed on the material surface using the single-point processing method have a length of approximately 115 micrometers, resulting in greater material loss. Please refer to FIG. 10, FIG. 10 shows the surface condition of the material after processing by using the laser processing system of an embodiment of this disclosure. As shown in FIG. 10, by utilizing the laser processing system of an embodiment of this disclosure, a multi-point intensity-staggered processing method is applied to form a continuous modified region within the material. This approach may reduce local thermal stress differences, ensure uniform crack lengths, and effectively enhance the success rate of subsequent die separation. Specifically, as shown in FIG. 10, the processing method with multi-point intensity staggered distribution forms cracks of approximately 150 micrometers in length on the material surface, resulting in minimal material loss.

In order to further verify the processing effect of the embodiment of this disclosure, a die separation experiment was conducted on a silicon carbide substrate with dimensions of 1 cm by 1 cm using the laser processing system of an embodiment of this disclosure. After scanning processing with the laser processing system of this disclosure, continuous cracks and openings may be observed on the side of the substrate. Then, an ultrasonic process is used to assist in die separation, which may be completed within a few minutes. Compared to the single-point processing method, the laser modification speed has been effectively increased. In addition, after performing die separation on a 6-inch wafer using the technology of the embodiment of this disclosure, the time required for laser modification may be 0.3 hours, which is approximately 13 times more efficient compared to single-point laser processing. Furthermore, the die separation yield may increase to over 90% (approximately 3 times improvement), and the surface roughness (Sa) of the wafer may decrease from 4.44 micrometers to 4.35 micrometers. These results demonstrate the potential of the technology in the embodiment of this disclosure to be configured for die separation on larger area wafers.

In view of the above description, the laser processing system and optical diffraction element disclosed in this disclosure, by using a specially designed optical diffraction element, may diffract the laser light to generate two diffracted lights that are staggered with each other in one-dimensional direction and have different intensities so as to perform internal modification on the object to be processed. Therefore, the laser processing system and optical diffraction element disclosed in this disclosure may form cracks along the one-dimensional direction in the internal modification area of the object to be processed, thereby enlarging the laser scan spacing, connecting the cracks, and improving the laser modification speed and die separation yield.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A laser processing system for internal modification on an object to be processed, comprising:
a laser source configured to generate a laser beam;
an optical diffraction element optically coupled to the laser source, the optical diffraction element having a surface with a plurality of first periodic structures and a plurality of second periodic structures staggered with each other, each of the plurality of first periodic structures comprising a plurality of first microstructures with same characteristic length, each of the second periodic structures comprising a plurality of second microstructures with same characteristic length, the optical diffraction element configured to generate a plurality of first diffracted lights and a plurality of second diffracted lights staggered with each other from the laser beam; and
a focusing lens set optically coupled to the optical diffraction element, and configured to focus the plurality of first diffracted lights and the plurality of second diffracted lights to an object to be processed.

2. The laser processing system according to claim 1, wherein the optical diffraction element is a grating.

3. The laser processing system according to claim 1, wherein each of the plurality of first periodic structures and each of the plurality of second periodic structures have same structural length.

4. The laser processing system according to claim 1, wherein a quantity of the plurality of first microstructures of each of the plurality of first periodic structures is greater than a quantity of the plurality of second microstructures of each of the plurality of second periodic structures.

5. The laser processing system according to claim 1, wherein the characteristic length of the plurality of first microstructures is smaller than the characteristic length of the plurality of second microstructures.

6. The laser processing system according to claim 1, wherein all of the plurality of first microstructures are stair-shaped, and all of the plurality of second microstructures are stair-shaped.

7. The laser processing system according to claim 1, wherein all of the plurality of first microstructures are sawtooth-shaped, and all of the plurality of second microstructures are sawtooth-shaped.

8. The laser processing system according to claim 1, wherein a quantity of the plurality of first microstructures of each of the plurality of first periodic structures is 4, and a quantity of the plurality of second microstructures of each of the plurality of second periodic structures is 2.

9. An optical diffraction element, configured to generate a plurality of first diffracted lights and a plurality of second diffracted lights staggered with each other from a laser beam, the optical diffraction element comprising:
a plurality of first periodic structures, each comprising a plurality of first microstructures with same characteristic length; and
a plurality of second periodic structures, each comprising a plurality of second microstructures with same characteristic length, wherein the plurality of first periodic structures and the plurality of second periodic structures are staggered with each other, the quantity of the plurality of first microstructures of each of the plurality of first periodic structures is greater than the quantity of the plurality of second microstructures of each of the plurality of second periodic structures.

10. The optical diffraction element according to claim 9, wherein the optical diffraction element is a grating.

11. The optical diffraction element according to claim 9, wherein each of the plurality of first periodic structures and each of the plurality of second periodic structures have same structural length.

12. The optical diffraction element according to claim 9, wherein the characteristic length of each of the first microstructures is smaller than the characteristic length of each of the second microstructures.

13. The optical diffraction element according to claim 9, wherein all of the plurality of first microstructures are stair-shaped, and all of the plurality of second microstructures are stair-shaped.

14. The optical diffraction element according to claim 9, wherein all of the plurality of first microstructures are sawtooth-shaped, and all of the plurality of second microstructures are sawtooth-shaped.

15. The optical diffraction element according to claim 9, wherein the quantity of the first microstructures of each of the plurality of first periodic structures is 4, and the quantity of the second microstructures of each of the plurality of second periodic structures is 2.
